(19) United States
(12) Patent Application Publication
(10) Pub. No.: US 2010/0014287 A1
(43) Pub. Date: Jan. 21, 2010

(54) ILLUMINATING DEVICE WITH HEAT DISSIPATING ELEMENT

(75) Inventors: KUO-FENG CHIANG, Chu-Nan (TW); YI-KAI CHENG, Chu-Nan (TW); YING-CHIEH LU, Chu-Nan (TW); PING-YU CHEN, Chu-Nan (TW); HUNG-KUANG HSU, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/494,265

(22) Filed: Jun. 29, 2009

(30) Foreign Application Priority Data
Jul. 18, 2008 (CN) 200810302786.7

(51) Int. Cl. F21V 9/00; F21S 4/00; F21V 29/00

(52) U.S. Cl. 362/231; 362/249.02; 362/373

(57) ABSTRACT

An exemplary illuminating device includes a circuit board, a plurality of light sources, a thermal interface material, and a plurality of stretched resilient elements. The circuit board has a first surface and a second surface at an opposite side of the circuit board to the first surface. The plurality of light sources is electrically mounted on the first surface of the circuit board. The heat dissipating device is attached on the second surface of the circuit board. The thermal interface material is applied between the second surface of the circuit board and the heat dissipating device. The plurality of resilient elements are configured for connecting the circuit board with the heat dissipating device and providing a pulling force therebetween.

### BACKGROUND

1. Technical Field

The present invention relates to illuminating devices, and particularly, to an illuminating device incorporating a heat dissipating element.

2. Discussion of Related Art

At present, light-emitting diodes (LEDs) are popularly used as illuminating devices.

Generally, heat produced by the illuminating device can be transferred via air convection and dissipated into the external environment. However, the air has a relatively small thermal conductivity coefficient, and, as such, heat dissipation is slow. Eventually, the heat accumulated around the illuminating device will influence the light intensity of the LED, thereby reducing the operation life thereof.

Therefore, what is needed is an illuminating device to overcome the above-described deficiencies.

### BRIEF DESCRIPTION OF THE DRAWINGS

Many aspects of various exemplary embodiments can be better understood with reference to the following drawings. The components in the drawings are not necessarily drawn to scale, the emphasis instead being placed upon clearly illustrating the principles of the embodiments. Moreover, in the drawings, all the views are schematic, and like reference numerals designate corresponding parts throughout the several views.

FIG. 1 is a schematic, isometric view of an illuminating device in accordance with a first embodiment.

FIG. 2 is an exploded view of the illuminating device shown in FIG. 1.

FIG. 3 is a front view of an illuminating device in accordance with a second embodiment.

### DETAILED DESCRIPTION

Reference will now be made to the drawings to describe in detail of the embodiments of the illuminating device.

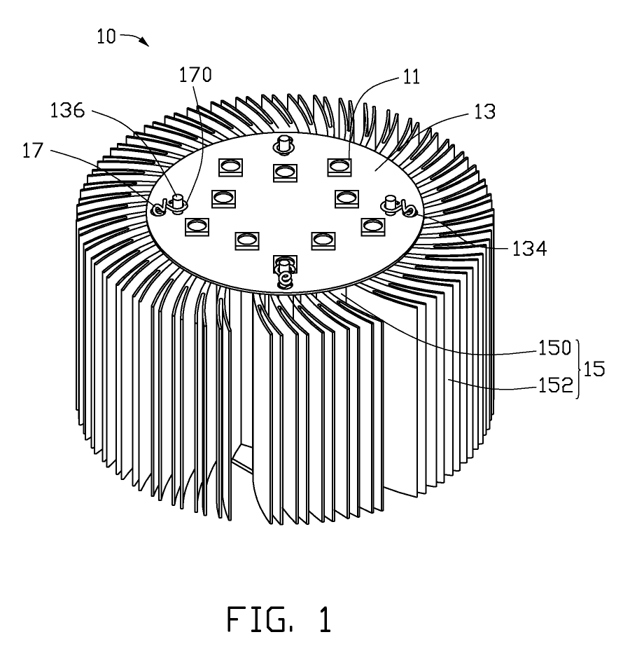

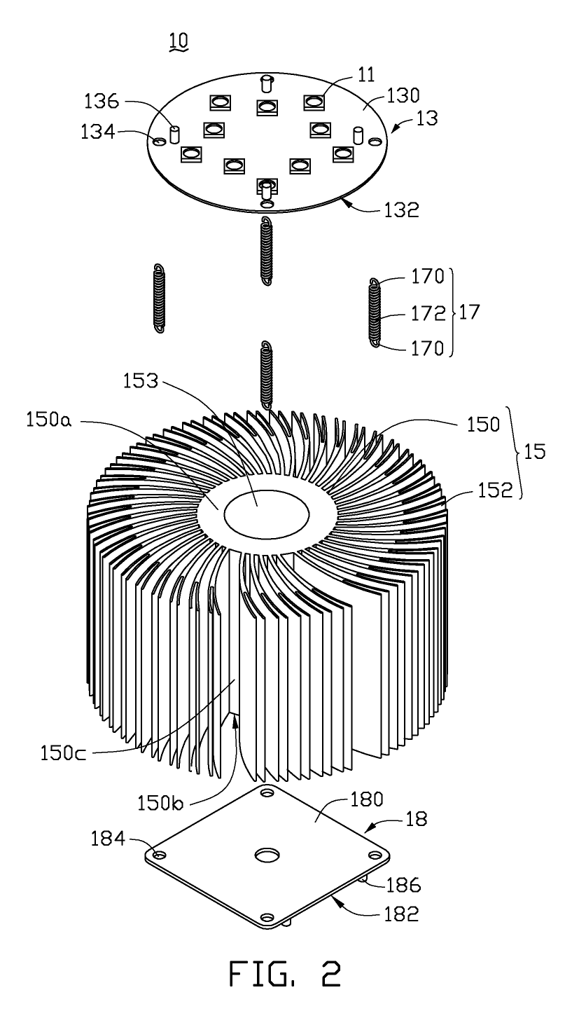

Referring to FIGS. 1 and 2, an illuminating device 10 in accordance with a first embodiment includes at least one light source, a circuit board 13, a heat dissipating device 15, a plurality of resilient elements, and a supporting board 18 having a first surface 180 and a second surface 182 facing away from the first surface 180.

In the first embodiment, the at least one light source consists a plurality of LEDs 11. The plurality of LEDs 11 can be selected from the group consisting of white LED, green LED, red LED, and blue LED.

The circuit board 13 includes a first surface 130 and a second surface 132 facing away from the first surface 130. The plurality of light sources 11 is electrically attached to the first surface 130 of the circuit board 13. In the first embodiment, the circuit board 13 is a metal core printed circuit board (MCPCB). In alternative embodiments, the circuit board 13 can be a ceramic circuit board, a glass fiber board, etc.

In the first embodiment, the heat dissipating device 15 includes a cylinder shaped main body 150 and a plurality of cooling fins 152. The main body 150 includes a top surface 150a, a bottom surface 150b facing away from the top surface 150a, and a cylindrical surface 150c interconnecting the top surface 150a and the bottom surface 150b. The cooling fins 152 axially and radially extend from the cylindrical surface 150c of the main body 150.

The circuit board 13 is attached on the top surface 150a of the main body 150. The area of the circuit board 13 is bigger than that of the top surface 150a of the main body 150, so that the circuit board 13 can cover entire area of the top surface 150a. In the first embodiment, a thermal interface material 153 is applied between the second surface 132 of the circuit board 13 and the top surface 150a of the main body 150 in order to fill air spaces therebetween, thereby promoting efficient heat transfer. The thermal interface material 153 can be selected from the group consisting of thermally conductive adhesive, phase change metal alloy, thermal grease, silicon gap filler and heat conductive insulating adhesive. The supporting board 18 is attached on the bottom surface 150b with the first surface 180 contacting the bottom surface 150b. The area of the supporting board 18 is bigger than that of the bottom surface 150c of the main body 150, so that the supporting board 18 can cover entire area of the bottom surface 150c.

The plurality of stretched resilient elements connect the circuit board 13 with the supporting board 18 to make the circuit board 13 and the supporting board 18 come closer together, i.e. to make the second surface 132 of the circuit board 13 tightly contact the top surface 150a of the main body 150 and the supporting board 18 tightly contact the bottom surface 150b of the main body 150.

In the first embodiment, the resilient elements are four coil springs 17. Each of the springs 17 includes a coil spring portion 172 and two spring hooks 170 on each end of the coil spring portion 172, respectively. The circuit board 13 includes four through holes 134 defined in the periphery portion of the circuit board 13 and four pins 136 protruding from the first surface 130 of the circuit board 13 arranged near the corresponding through holes 134. The supporting board 18 includes four through holes 184 defined in the periphery portion of the supporting board 18 and four pins 186 protruding from the second surface 182 of the supporting board 18 arranged near the corresponding through holes 184.

During assembly, one hook portion 170 of each coil spring 17 is inserted through one through hole 134 of the circuit board 13 and fastened to the adjacent pin 136. Another hook portion 170 of each coil spring 17 is inserted through one corresponding through hole 184 of the supporting board 18 and fastened to the adjacent pin 186. The coil spring portion 172 of each coil spring 17 is interposed in the corresponding space between adjacent fins 152. The coil spring portion 170 of each coil spring 17 are stretched, thereby preloading a pulling force between the circuit board 13 and the supporting board 18. Therefore, the second surface 132 of the circuit board 13 can tightly contact the top surface 150a of the main body 150 and the supporting board 18 can tightly contact the bottom surface 150b of the main body 150. The tight contacting between the circuit board 13 and the heat dissipating device 15 increases the work efficiency of the thermal interface material 153 in the air spaces therebetween. Even if the thermal interface material 153 is lost, the heat generated by the LEDs 11 can be well conducted to the heat dissipating device 15.

In alternative embodiments, another hook portion 170 of each coil spring 17 can be fastened to the bottom surface 150b of the main body 150, therefore, the supporting board 18 can be omitted. It is to be understood that, the through holes 134 also can be omitted, and the one hook portion 170 of each coil spring 17 is fastened to the adjacent pin 136 directly.

It is to be understood that, the ends of the resilient elements can be welded on the circuit board 13 and the supporting board 18. The resilient elements can be rubber bands or other suitable resilient elements known by the person skilled in the art.

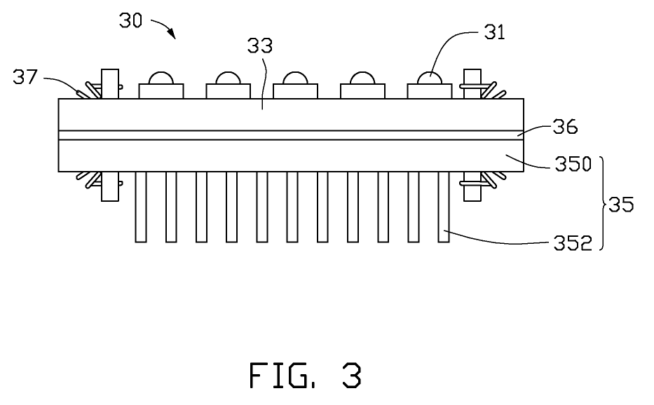

Referring to FIG. 3, an illuminating device 30 in accordance with a second embodiment includes at least one light source 31, a circuit board 33, a heat dissipating device 35, a plurality of resilient elements 37. The heat dissipating device 35 includes a flat substrate 350 and fins 352 formed on the substrate 350. A thermal interface material 36 is applied between the circuit board 33 and the substrate 350 in order to fill air spaces therebetween thereby promoting efficient heat transfer. The resilient elements 37 are configured for connecting the circuit board 33 with the substrate 350 and preloading pulling force therebetween, thereby promoting efficient heat transfer from the circuit board to the heat dissipating device 35.

It is to be understood, however, that even though numerous characteristics and advantages of various embodiments have been set forth in the foregoing description together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. An illuminating device, comprising:
a circuit board having a first surface and a second surface facing away from the first surface;
a plurality of light sources electrically mounted on the first surface of the circuit board;
a heat dissipating device disposed on the second surface of the circuit board;
a thermal interface material applied between the second surface of the circuit board and the heat dissipating device; and
a plurality of stretched resilient elements connected between the circuit board and the heat dissipating device for providing a pulling force between the circuit board and the heat dissipating device.

2. The illuminating device as claimed in claim 1, wherein the plurality of light sources are light-emitting diodes.

3. The illuminating device as claimed in claim 2, wherein the light-emitting diodes are selected from the group consisting of white light-emitting diodes, green light-emitting diodes, red light-emitting diodes, and blue light-emitting diodes.

4. The illuminating device as claimed in claim 1, wherein the thermal interface material is selected from the group consisting of thermally conductive adhesive, phase change metal alloy, thermal grease, silicon gap filler, and heat conductive insulating adhesive.

5. The illuminating device as claimed in claim 1, wherein the circuit board is selected from the group consisting of a metal core printed circuit board, a ceramic circuit board, and a glass fiber board.

6. The illuminating device as claimed in claim 1, wherein the heat dissipating device comprises a cylinder shaped main body and a plurality of fins, the main body having a top surface, a bottom surface facing away from the top surface, and a cylindrical surface interconnecting the top surface and the bottom surface, the fins axially and radially extending from the cylindrical surface of the main body.

7. The illuminating device as claimed in claim 6, wherein the second surface of the circuit board is attached on the top surface of the main body and the thermal interface material is applied between the second surface of the circuit board and the top surface of the main body.

8. The illuminating device as claimed in claim 7, wherein the resilient elements connect the circuit board with the bottom surface of the main body.

9. The illuminating device as claimed in claim 6, further comprising a supporting board attached on the bottom surface of the main body, wherein the resilient elements connect the circuit board with the supporting board.

10. The illuminating device as claimed in claim 1, wherein the heat dissipating device comprises a flat substrate and a plurality of fins formed on one surface of the substrate, and the resilient elements connect the circuit board with the substrate of the heat dissipating device.
